(19) United States
(12) Patent Application Publication
(10) Pub. No.: US 2021/0110460 A1
(43) Pub. Date: Apr. 15, 2021

(54) Using Augmented Reality to Depict Pre-Qualified Purchases

(71) Applicant: Wells Fargo Bank, N.A., San Francisco, CA (US)

(72) Inventors: Blair E. Barklow, San Francisco, CA (US); Chris Kalaboukis, San Jose, CA (US); Jennifer L. Copeland, San Francisco, CA (US)

(21) Appl. No.: 15/292,787

(22) Filed: Oct. 13, 2016

(51) Int. Cl. G06Q 30/06; G06Q 50/00; G06Q 40/02; G06F 3/0482

(52) U.S. Cl. CPC G06Q 30/0635; G06Q 30/0643; G06T 11/00; G06Q 40/02; G06F 3/0482; G06Q 50/01

(57) ABSTRACT

A list of products that a user is pre-qualified to purchase is received at an augmented reality device from an electronic computing device. One or more virtual objects are received from the electronic computing device. Each of the virtual objects is associated with one of the products that the user is pre-qualified to purchase. An image is received of a view obtained via the augmented reality device. One or more positions are identified in the view in which to display one or more of the virtual objects. The virtual objects are displayed in the identified one or more positions on the image of the view. A selection is received of a virtual object of the one or more virtual objects. The virtual object is associated with a product that the user is pre-qualified to purchase. A purchase of the product is initiated.

### BACKGROUND

Individuals often keep a list or think about products or services that they may be interested in purchasing. The products and services may be those that the individuals believe they need and those that they would like to have. Sometimes the individuals are not aware of the cost of the products and services for which they have an interest. Other times the individuals may not be aware of alternate products and services.

### SUMMARY

Embodiments of the disclosure are directed to a method implemented on an augmented reality device, the method comprising: receiving from an electronic computing device a list of one or more products that a user is pre-qualified to purchase; receiving from the electronic computing device one or more virtual objects, each of the one or more virtual objects being associated with one of the one or more products that the user is pre-qualified to purchase; receiving an image of a view obtained via the augmented reality device; identifying one or more positions in the view obtained from the augmented reality device in which to display one or more of the virtual objects; displaying the one or more virtual objects in the identified one or more positions on the image of the view; receiving a selection of a first virtual object of the one or more virtual objects, the first virtual object being associated with a first product of the one or more products that the user is pre-qualified to purchase; and initiating a purchase of the first product.

In another aspect, a method implemented on a server computer for identifying products and services that a user can purchase comprises: obtaining information from a plurality of sources regarding products and services that the user may have an interest in purchasing; using the information from the plurality of sources, automatically creating a list of products and services for which the user may wish to purchase; receiving a selection from the user of one of the products or services; determining whether the user can afford to purchase the one of the products or services; and sending a message to the user indicating whether the user can afford to purchase the one of the products or services.

In yet another aspect, an augmented reality electronic computing device comprises: a processing unit; and system memory, the system memory including instructions which, when executed by the processing unit, cause the augmented reality electronic computing device to: receive from a server computer a list of one or more products that a user is pre-qualified to purchase; receive from the server computer one or more virtual objects, each of the one or more virtual objects being associated with one of the one or more products that the user is pre-qualified to purchase; receive an image of a view obtained via the augmented reality electronic computing device; identify one or more positions in the view obtained from the augmented reality electronic computing device in which to display one or more of the virtual objects; display the one or more virtual objects in the identified one or more positions on the image of the view; display a virtual indicator on each side of each of the one or more virtual objects; receive a selection of a first virtual indicator, the first virtual indicator being located on a first side of a first virtual object associated with the first virtual indicator, the first virtual object being associated with a first product; replace the first virtual object with a second virtual object, the second virtual object being associated with a second product, the second product being more expensive than the first product; receive a selection of the second virtual object; and initiate a purchase of the second product.

The details of one or more techniques are set forth in the accompanying drawings and the description below. Other features, objects, and advantages of these techniques will be apparent from the description, drawings, and claims.

### DESCRIPTION OF THE DRAWINGS

FIG. 1 shows an example system that supports the use of augmented reality to depict pre-qualified purchases.

FIG. 2 shows an example scene viewable on the AR device of FIG. 1.

FIG. 3 shows another example scene viewable on the AR device of FIG. 1.

FIG. 4 shows a method implemented on the server computer of FIG. 1 for creating a pre-qualified list of products and services for purchase.

FIG. 5 shows a method implemented on the AR device of FIG. 1 for displaying virtual representations of products and services.

FIG. 6 shows a method implemented on the AR device of FIG. 1 for displaying virtual representations of alternate products and services.

FIG. 7 shows example physical components of the server computer of FIG. 1.

### DETAILED DESCRIPTION

The present disclosure is directed to systems and methods for using augmented reality (AR) to display information regarding products and services that an individual may be interested in purchasing. The products and services can be pre-qualified by a financial institution that has information regarding a financial health of the individual. The systems and methods permit the individual to view products and services that have been pre-qualified for the individual to purchase. The systems and methods permit a price for the goods and services to be displayed and permit the individual to replace a viewed product or service for a more or less expensive product and service. In addition, the systems and methods permit the individual to purchase the product using an AR device on which the products and services are displayed.

The individual can be a customer of an organization that sells products and services, such as a retailer. The individual can also be a customer of a financial institution such as a bank. For a discussion of the systems and methods in this disclosure, the individual is assumed to be a customer of a financial institution. In this disclosure, the individual may also be referred to as a customer or a user.

In one example implementation, a customer of a financial institution may be viewing a room in the customer's home using the AR device. The financial institution may know that the customer is interested in purchasing one or more products for the home. The financial institution can obtain information about the customer's interests through surveys or other inputs provided to the financial institution, through a knowledge of the customer's previous purchases, through knowledge of the customer's browser and search history, though an evaluation of the customer's social media accounts and conversations, through an evaluation of the customer's email accounts and conversations and through other sources.

The financial institution can compile a list of products and services for which the customer has shown an interest or that may be compatible with products and services purchased by other similar customers. The list of products and services can be adjusted based on an evaluation of the customer's financial health. As a result, the financial institution can compile a list of products and services for which the customer is pre-qualified to purchase.

The financial institution can also access a database of virtual objects and obtain a virtual object representing a product or service for each product and service on the list. The financial institution can send the list of pre-qualified products and services and the virtual objects to the AR device.

In the example implementation discussed, the AR device can analyze the customer's room and display the virtual objects in appropriate positions in the room. For example, virtual objects corresponding to a chair, a lamp, a high-definition television and other products can be placed at appropriate positions in the room. In addition, the AR device can display virtual indicators near each virtual object. The virtual indicators can display a price of the product or service, can provide an indication of whether the customer can afford the product or service and can permit the customer to replace a product or service with a more expensive or less expensive product or service.

In another example implementation, the customer can view a driveway of the customer's home using the AR device. When the financial institution knows that the customer is in the market for a new car and has learned of a particular make and model of a car for which the customer has indicated an interest, the financial institution can send a virtual image of the make and model of the car to the AR device. The AR device can in turn display the virtual image of the car on the customer's driveway. The AR device can also display a retail price of the car and an indication of whether the customer can afford the car. In addition, the AR device can display virtual indicators which can permit the customer to select a different car or to replace the car with a more expensive or less expensive model. Other example implementations are possible.

The systems and methods disclosed herein are directed to a computer technology that can improve an efficiency of a shopping experience for a user of an AR device. The systems and methods permit a server computer to automatically identify products and services that the user has expressed interest in purchasing. The systems and methods can also automatically determine user affordability for the products and services, automatically generate a pre-qualified list of the products and services, obtain virtual images that correspond to the products and services and display the virtual images at optimized locations on a scene viewed by the AR device. In addition, the systems and methods can permit the user to purchase the products or services by selecting a virtual image corresponding to a desired product or service at the AR device.

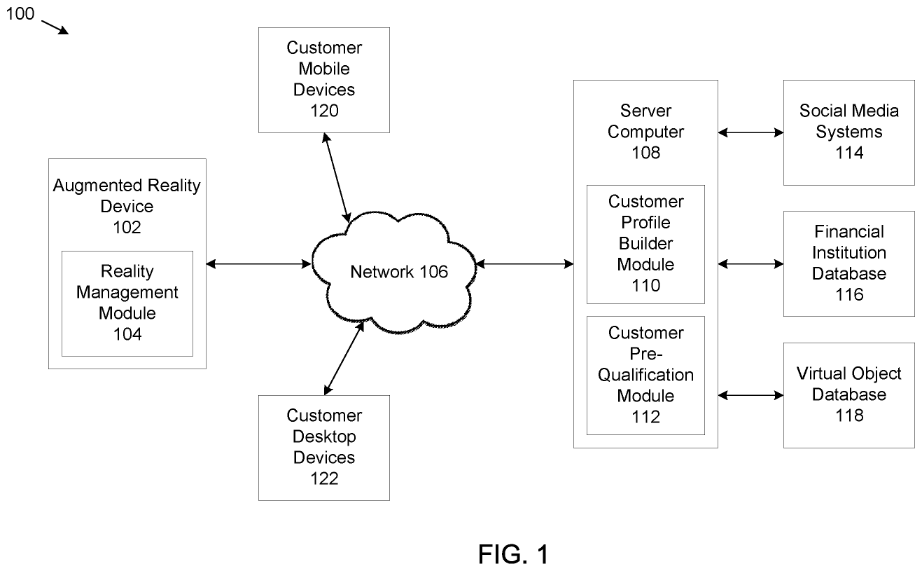

FIG. 1 shows an example system 100 that can support the use of augmented reality (AR) to depict pre-qualified purchases. The system 100 includes an AR device 102, a network 106, a server computer 108, social media systems 114, a financial institution database 116, a virtual object database 118, customer mobile devices 120 and customer desktop devices 122. The AR device 102 includes a reality management module 104. The server computer 108 includes a customer profile builder module 110 and a customer pre-qualification module 112. More, fewer or different components are possible.

The example AR device 102 is an electronic computing device with an AR functionality that can be worn or carried by the customer. An example of an AR device that may be worn by the user is an AR headset. An example of an AR device that may be carried by the user is a smart telephone or tablet computer that includes AR components such as a processor, display and camera and an AR software application. The smart phone or tablet computer can display a virtual image on a display screen of the smart phone or tablet computer.

The AR headset includes a wearable computer, a camera and an optical display. The wearable computer includes a wireless telecommunication capability, permitting a wireless connection between the wearable computer and one or more server computers. The wearable computer also includes voice recognition capability, permitting the user to direct the wearable computer via voice commands. The optical display projects virtual images and also permits the user to see through the display. An example of an AR headset is Google Glass, from Google Inc. of Mountain View, Calif.

The example reality management module 104 manages AR device 102 and displays virtual images to the customer. The virtual images are based on a list of pre-qualified products and services for the customer and associated virtual objects. The pre-qualified products, services and associated virtual objects are identified by server computer 108 as a result of an analysis of the customer's interests and financial health. The reality management module 104 also analyzes an actual view from the camera of AR device 102 and determines appropriate locations and positions in the actual view at which to display the virtual objects. In some implementations, the locations and positions in the actual view at which to display the virtual objects can be determined by server computer 108.

The example network 106 is a computer network such as the Internet. A user of AR device 102 can login to server computer 108 across network 106.

The example server computer 108 is a server computer of a financial institution such as a bank. The customer can have one or more financial accounts at the financial institution. Server computer 108 can store financial records for the customer at server computer 108, at financial institution database 116 or at another server computer or database accessible from server computer 108.

The example customer profile builder module 110 can capture personal customer data and build a personal profile for the customer. The personal customer data can be captured from a plurality of sources including a scan of a customer's social media stream, a scan of the customer's mobile and desktop browser history, a scan of the customer's email conversations and a review of the customer's purchase history. An opt-in and permission from the customer is required for the customer profile builder module 110 to capture the personal customer data. The customer can opt-in and give permission for a select number of items, for example for a scan of the customer's social media stream and browser history, but not a scan of the customer's email conversations. The customer profile builder module 110 can analyze the personal customer data and identify possible future products and services that the customer may be interested in purchasing.

The example customer pre-qualification module 112 can access customer financial information and determine a financial health status of the customer. The financial health status can be based on a determination of the customer's current income, employment history, short term and long term debt, investments and other assets. The customer pre-qualification module 112 can use financial health status of the customer to identify products and services that the customer has an interest in purchasing and that are affordable for the customer. The customer pre-qualification module 112 can pre-qualify the customer for a set of products and services that the customer can afford to purchase.

The example social media systems 114 can include one or more server computers that host social media sites. When given permission by the customer, server computer 108 can access social media streams for the customer, typically via an application program interface, on one or more of the social media systems 114.

The example financial institution database 116 is a database of the financial institution of the customer. The financial institution database 116 can include financial account information for the customer. The financial account information can include information regarding savings accounts, checking accounts, mortgages, personal loans, credit card purchase history and other financial account information. The financial institution database 116 can also include personal profile information including employment history and family information.

The example virtual object database 118 can include a plurality of virtual objects that can be accessed by server computer 108. One or more virtual objects can be selected that can represent one or more products and services for which the customer is pre-qualified. The selected virtual objects can be sent by server computer 108 to AR device 102 for display on AR device 102.

The example customer mobile devices 120 can comprise one or more mobile electronic computing devices that the customer uses. The mobile electronic computing devices can include smartphones, tablet computers and laptop computers. When customer permission is obtained, server computer 108 can scan a browser history and email conversation history that can be stored on one or more of customer mobile devices 120. The browser history and email conversation history from the customer mobile devices 120 can be used by the customer profile builder module 110 to help create a list of products and services for which the customer may be interested in purchasing.

The example customer desktop device 122 can comprise one or more desktop computers that are used by the customer. When customer permission is obtained, server computer 108 can scan a browser history and email conversation history that can be stored on one or more of customer desktop devices 122. The browser history and email conversation history from the customer desktop devices 122 can be used by the customer profile builder module 110 to help create a list of products and services for which the customer may be interested in purchasing.

In an example implementation using system 100, permission can be given by the customer to access social media sites for which the customer has an account and to obtain a browser history from the customer's desktop and mobile devices. Server computer 108 can then access social media systems 114, customer mobile devices 120 and customer desktop devices 122 to obtain the customer's social media stream and browser history. The customer profile builder module 110 can then mine the customer's social media stream and browser history to obtain hints regarding potential purchases of products and services by the customer. The customer profile builder module 110 can use the hints and any other relevant information, such as a customer purchase history, to create a list of products and services for which the customer may be interested in purchasing. The customer purchase history can be obtained from information stored on server computer 108 or on other systems, for example financial institution database 116, that are accessible from server computer 108.

When the list of products and services for which the customer may be interested in purchasing is created, the customer pre-qualification module 112 can access customer financial information stored on server computer 108 and financial institution database 116. A financial health status of the customer can be determined. The customer pre-qualification module 112 can use the financial health status of the customer to determine customer affordability for the products and services on the list of products and services for which the customer may be interested in purchasing. The customer pre-qualification module 112 can then pre-qualify the customer for the products and services for which the customer can afford and create a pre-qualification list of products and services for the customer.

When the pre-qualification list is created, server computer 108 can access virtual object database 118 to obtain virtual objects that correspond to the products and services on the pre-qualification list. Server computer 108 can then send the pre-qualification list and the obtained virtual objects to AR device 102.

When AR device 102 obtains the pre-qualification list and the obtained virtual objects, the reality management module 104 can analyze a scene being viewed by AR device 102 and determine an optimal location for some of the pre-qualified products. Reality management module 104 can then place virtual objects corresponding to the pre-qualified products at the determined optimal location on the scene viewed by AR device 102. As discussed in more detail later herein, the customer can select a product and service to purchase or can replace a displayed product or service with a different product or service.

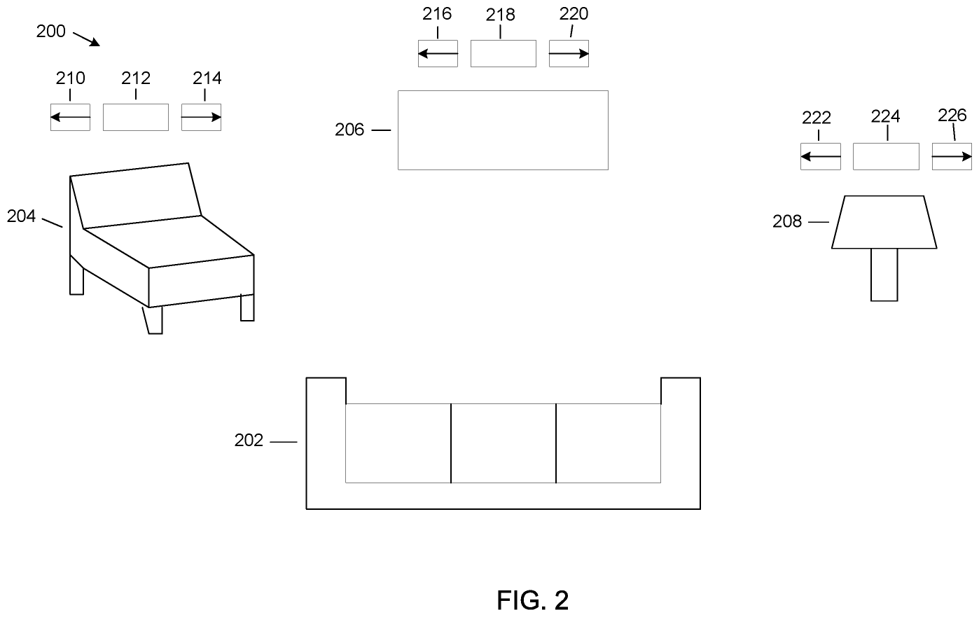

FIG. 2 shows an example scene 200 viewed by AR device 102. The scene 200 is an example scene of a room in the customer's home. Some elements in the scene 200 are actual elements in the room and other elements in the scene are virtual elements inserted as overlays on a display screen of AR device 102. For clarity, not all actual elements in the room or virtual elements are shown in scene 200.

As shown in FIG. 2, scene 200 includes an actual sofa 202 and three virtual objects. Each of the virtual objects is displayed as an overlay of the scene 200. The example three virtual objects include a recliner 204, a high-definition television (HDTV) 206 and a lamp 208. The recliner 204, HDTV 206 and lamp 208 are determined to be products that customer is interested in purchasing. The reality management module 104 places the virtual objects at locations in the room that the reality management module 104 determines may be optimal locations for the customer. For example, the HDTV 206 is placed directly opposite the sofa 202, the recliner 204 is placed at an empty spot at the left of the room and the lamp 208 is placed at the right of the room. If the customer does not like the locations of the virtual objects, the customer can drag each virtual object to a location in the room of the customer's liking. The customer can also rotate a virtual object and adjust a position of a virtual object. The customer can use hand gestures to rotate or adjust the positon of the virtual object.

The reality management module also places three virtual indicators near each virtual object. For example, virtual indicators 210-214 are placed above recliner 204, virtual indicators 216-220 are placed above HDTV 206 and virtual indicators 222-226 are placed above lamp 208. For example system 100, the center virtual indicators, for example virtual indicators 212, 216 and 224 can display a price of the product associated with the virtual indicator (for example, recliner 204, HDTV 206 and lamp 208, respectively). In addition, virtual indicators 212, 216 and 224 can indicate whether the product associated with the virtual indicator is affordable to the customer. In some implementations, when the product is affordable to the customer, the price is shown in a green color and when the product is not affordable to the customer, the price is shown in a red color. In other implementations, a background of the center virtual indicator can be green for an affordable product and red for an unaffordable product. Other means of showing affordability are possible.

The left and right virtual indicators permit the customer to replace the product with a more or less expensive product. For example, if the customer thinks that the price of the HDTV 206 is too high, the customer can select left virtual indicator 216. When left virtual indicator 216 is selected, the virtual image of HDTV 206 is replaced with a virtual image of a less expensive HDTV. Similarly, when the customer would like a better HDTV, the customer can select right virtual indicator 220. In this case the virtual image of HDTV 206 is replaced with a virtual image of a more expensive HDTV.

The customer can select the left virtual indicator 216 by either tapping the left virtual indicator 216 or by making a left gesture from virtual object 218 towards the left virtual indicator 216. Similarly, the customer can select the right virtual indicator 220 by either tapping the right virtual indicator 220 or making a right gesture from virtual object 218 towards the right virtual indicator 220. Other right and left virtual indicators can be selected in a similar manner.

In system 100, the customer can also purchase a displayed product using AR device 102. For example, in an example implementation, the customer can purchase the product by selecting the center virtual indicator associated with the product the user wishes to purchase. For example, when the customer wants to purchase the recliner 204, the customer can select center virtual indicator 212, when the customer wants to purchase the HDTV 206, the customer can select center virtual indicator 218 and when the customer wants to purchase the lamp 208, the customer can select center virtual indicator 224. Each virtual indicator can be selected by tapping on the virtual indicator as displayed by AR device 102. When a center virtual indicator is selected, the customer can be prompted to confirm the proposed purchase and to give the customer a chance to cancel the proposed purchase, if necessary. The customer can select a center virtual indicator either by tapping the center virtual indicator or making a gesture towards the center virtual indicator.

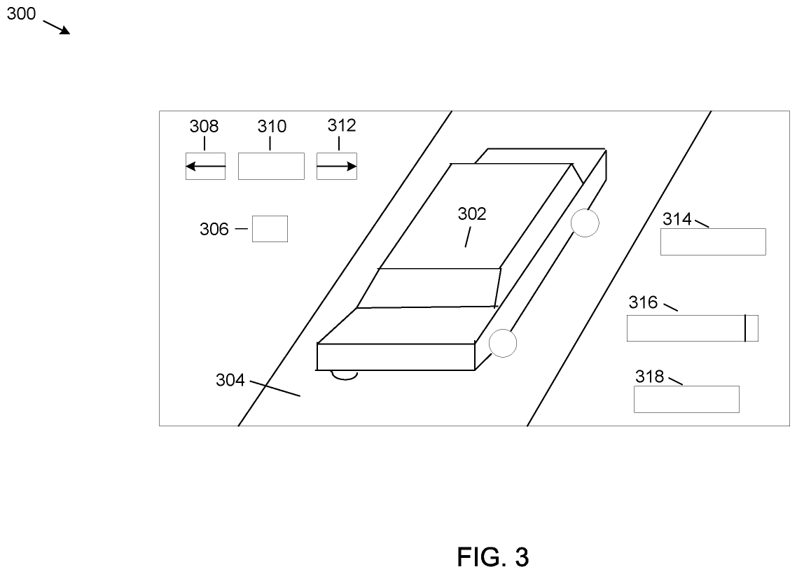

FIG. 3 shows another example scene 300 viewed by AR device 102. The example scene 300 is a scene of a driveway 304 at the customer's home. The scene 300 can be displayed when the customer views the driveway 304 with AR device 102. In some implementations, the customer can issue a verbal command at AR device 102, for example “display car” and the reality management module 104 can display a virtual image on the driveway of a car that the user has expressed interest in buying. For example, car 302 can be displayed. In other implementations, the reality management module 104 can determine from a GPS location of the customer that the customer is on or near the customer's driveway. The reality management module 104 can then display a virtual image of a car on the driveway of a make and model indicated on the customer pre-qualification list. The customer can walk around the virtual image of the car and view the car from different angles.

The example scene 300 also includes virtual indicators that can be displayed on AR device 102. Virtual indicators 308, 310 and 312 are similar to virtual indicators shown on FIG. 2. For example, virtual indicator 310 can display a price of the displayed car, virtual indicator 308 can permit the customer to replace the displayed car with a less expensive model and virtual indicator 312 can permit the customer to replace the displayed car with a more expensive model. The price can be displayed as a total price of the car or as a monthly payment. In some implementations, the customer can initiate a process to purchase the car by tapping or gesturing at virtual indicator 310.

FIG. 3 also shows three additional virtual indicators 306, 314, 316 and 318. Other virtual indicators are possible.

Example virtual indicator 306 can display an indication of whether the displayed car is affordable to the customer. For example, in one implementation, virtual indicator 306 can display a check mark when the displayed car is affordable and can display the letter “X” when the customer cannot afford the displayed car. In another implementation, virtual indicator 306 can be filled in with a green color when the displayed car is affordable and can be filled in with a red color when the customer cannot afford the displayed car. In some implementations, the customer can initiate a process to purchase the displayed car by tapping or gesturing towards virtual indicator 306 when virtual indicator 306 indicates that the car is affordable. In some implementations, the word “buy” or a similar word can be displayed using virtual indicator 306 when the car is affordable.

Example virtual indicator 314 is a payment advisor virtual indicator. The payment advisor virtual indicator can provide guidance to the customer for improving the customer's financial health in order to help the customer meet a purchase goal. For example the payment virtual indicator can display ideas such as earning more, paying less rent, reducing expenditures on coffee, etc., in order to save more money and improve the customer's cash flow.

Example virtual indicator 316 is a pull-down list box which can list available makes and models of vehicles. If the customer wants to compare other makes of cars with the one currently displayed on AR device 102, the customer can select a car manufacturer from the pull-down list box. For example, if the car currently displayed on AR device 102 is a Toyota, the customer can select a Honda from the virtual indicator 316. When the Honda is selected, a Honda a model is displayed that is comparable to the Toyota model currently displayed. The customer can then select a less expensive or more expensive Honda model by tapping on virtual indicator 308 and 312, respectively.

Example virtual indicator 318 is a list box which can list features of the car currently being displayed. Example features can include interior and exterior colors and options such as leather seats, an enhanced car entertainment system, and improved tires. The customer can select a feature and change the feature to add a more or less expensive feature. When the customer changes a feature, any change to the price of the car is shown on virtual indicator 310. In addition, virtual indicator 306 can indicate whether the car is still affordable to the customer based on the changed feature.

When the car is unaffordable, either because of the changed feature or because a make and model of car is selected that is unaffordable for the customer, and the customer still chooses to purchase the car, virtual indicator 314 can show an impact of the decision to purchase the unaffordable car on the customer's financial goals. For example, if the customer is saving to buy a house and the customer chooses to purchase a more expensive car than he or she can afford, virtual indicator 314 can show that purchasing the more expensive car will delay the purchase of the home by a specific number of months. The use of payment advisor virtual indicator 314, or another virtual indicator, to show a financial impact for purchasing an affordable product can apply to a broad variety of products and services.

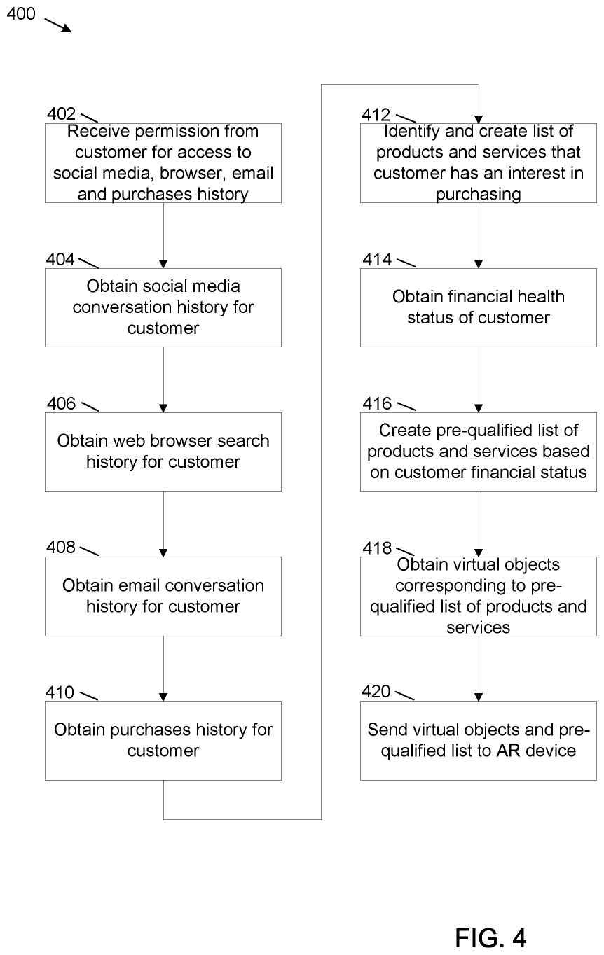

FIG. 4 shows a flowchart of an example method 400 for creating at a server computer a pre-qualified list of products and services of interest to a customer. In addition, the method obtains virtual objects corresponding to the pre-qualified products and services for display on an AR device. For method 400, the server computer is a financial institution server computer, for example server computer 108, at which the customer has one or more financial accounts.

At operation 402, permission is received from the customer to obtain access to one or more of social media conversations, search browser history, email account and conversation history and purchases history for the customer. Permission needs to be received for each type of access in order to the server computer to obtain the permitted access.

Social media access can comprise the ability to access a social media conversation history for the customer at one or more social media sites. Customer permission needs to be given for each social media site. The access is typically provided through an application programming interface (API) at the social media site. At operation 404, social media conversation history is obtained for the customer.

Search browser history access can comprise the ability to access a search browser history of the customer at one or more of the customer devices. The devices can include customer mobile devices 120, customer desktop devices 122 and AR device 102. At operation 406, web browser search history is obtained for the customer.

Email account and conversation history can comprise the ability to access email account information and email conversation history at one or more the of the customer devices. The devices can include customer mobile devices 120 and customer desktop devices 122. It may also be possible for the server computer to access one or more email server computers for which the customer has email accounts. At operation 408, email conversation history is obtained for the customer.

Purchases history access can comprise accessing one or more of the customer financial accounts at the financial institution server computer to obtain a listing of purchases of products and services made by the customer. The customer financial accounts can include one or more of checking accounts, debit card accounts and credit card accounts that the customer may have at the financial institution. At operation 410, a purchases history is obtained for the customer.

At operation 412, the server computer analyzes one or more of the social media conversation history, the web browser search history, the email history and the purchases history to identify one or more products and services that the customer may be interested in purchasing. The server computer can then create a list of the identified products and services.

At operation 414, a financial health status is obtained for the customer. The financial health status is obtained by analyzing the one or more financial accounts of the customer to determine such items as current income, current assets and current liabilities, such as personal loan debt, credit card debt and mortgage debt. In an example implementation, the customer pre-qualification module 112 of server computer 108 can determine the financial health status for the customer.

At operation 416, the list of identified products and services is modified based on the customer's financial health status to create a pre-qualified list of products and services. The pre-qualified list of products and services corresponds to products and services for which a determination is made that the customer can afford to purchase.

At operation 418, virtual objects are obtained corresponding to the pre-qualified list of products and services. The virtual objects are images that can represent the products and services on the pre-qualified list of products and services and that can be displayed as an overlay on an AR device. The virtual objects can be obtained from a virtual object database, for example virtual object database 118.

At operation 420, the virtual objects and the pre-qualified list of products and services are sent to the AR device, for example to AR device 102.

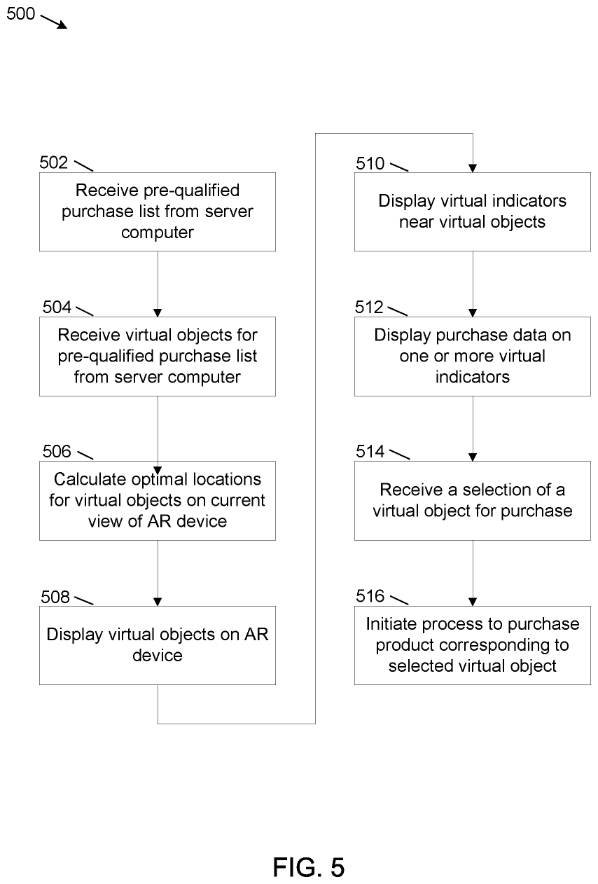

FIG. 5 shows a flowchart of an example method 500 for displaying virtual representations of products and services for the customer on an AR device. For method 500, the AR device is AR device 102.

At operation 502, a pre-qualified list of products and services for the customer is received at AR device 102 from a server computer. For method 500, the pre-qualified list of products and services corresponds to the pre-qualified list of products and services from operation 416 and the server computer corresponds to server computer 108.

At operation 504, virtual objects corresponding to the pre-qualified list of products and services are received from the server computer. For method 500, the virtual objects correspond to the virtual objects from operation 418.

At operation 506, reality management module 104 of AR device 102 calculates optimal locations for a display of the virtual objects on a current view of the AR device. The current view comprises a view obtained from a camera on AR device 102. For example, when AR device 102 is an AR headset, the view corresponds to what the headset is focused on. The reality management module 104 analyzes the view and determines where to place the virtual objects. For example, when the view corresponds to a room in the customer's home, the reality management module 104 can determine that an optimal location for a HDTV is at a location that can easily be viewed from a sofa in the room. In an alternative implementation, the customer can decide where to locate the virtual objects.

At operation 508, the virtual objects are displayed on AR device 102. The virtual objects are projected as an overlay on the current view captured by the camera on the AR device.

At operation 510, virtual indicators are displayed near the virtual objects. In an example implementation, three virtual indicators are displayed near each virtual object, similar to that shown in FIG. 2. A center virtual indicator can display a purchase price of a product corresponding to the associated virtual object. A left virtual indicator can permit the customer to request a virtual object for a less expensive model of the product associated with the current virtual object and a right virtual indicator can permit the customer to request a virtual object for a more expensive model of the product associated with the current virtual object. In other implementations, the virtual indicators can be placed in different orientations. In addition, more or fewer virtual objects can be displayed.

At operation 512, purchase data is displayed on one or more virtual indicators. For example, one virtual indicator can display a purchase price for the product associated with a virtual object. Another virtual indicator, or the same virtual indicator, can display an amount of monthly payments needed to purchase the product associated with the virtual object. Yet another virtual indicator can provide information regarding guidance to the customer to help the customer improve his/her financial health so that the customer can afford to purchase the product associated with the virtual object. Other functionality for the virtual objects is possible.

At operation 514, a selection is received for a product associated with a virtual object that the customer has decided to purchase. In an example implementation, the customer can select the product by tapping on a virtual indicator that displays a price of the product. In some implementations, the customer is only permitted to select a product for purchase that the server computer determines is affordable for the user. The product can be identified as affordable by a green color of the virtual indicator that displays the price or a display of the price with a green color. Other colors can be used to identify affordability. In other implementations, the customer may be permitted to purchase the product even when the server computer indicates that the product is not affordable for the customer. Typically, in these other implementations, a payment advisor virtual indicator may be displayed, specifying conditions the customer needs to agree to before the customer is permitted to purchase the product. The conditions are typically those that can improve the financial health of the customer, such as earning more money or reducing expenses, for example by eating out less often or obtaining an apartment with a lower rent.

As operation 516, a process is initiated at AR device 102 to purchase the product selected at operation 514. In an example implementation, the process can consist of sending a message to the server computer to indicate that the customer wishes to purchase the product. The server computer may send one or more messages to AR device 102 to confirm the request to purchase the product and to request information regarding an authorization for the purchase and for a method of payment. The server computer can then initiate a transaction to purchase the product.

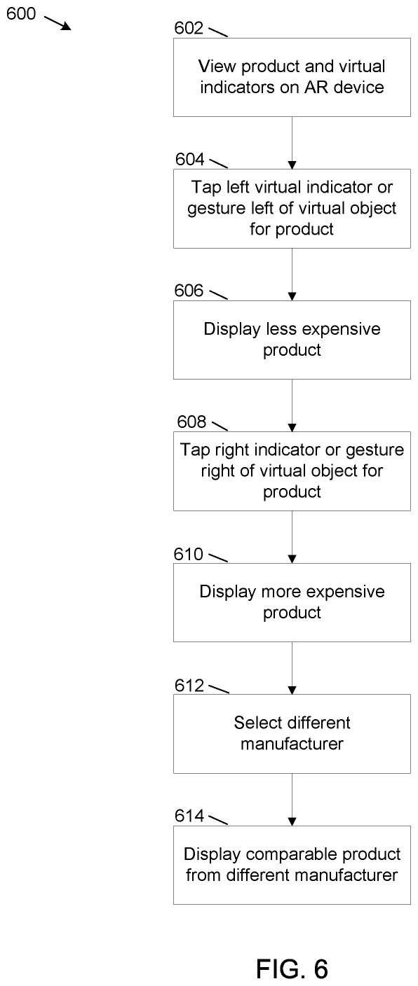

FIG. 6 shows a flowchart of an example method 600 for displaying on an AR device virtual representations of alternate products and services that differ from those on the pre-qualified list of products and services. The alternate products and services can be selected by using the virtual indicators described earlier herein to exchange the alternate products and services from currently displayed products or services. For method 600, the AR device is AR device 102.

At operation 602, a virtual representation of a product is viewed on the AR device. The product corresponds to a product on the pre-qualified list of products and services. Also displayed with the virtual representation of the product are three virtual indicators, similar to the virtual indicators of FIG. 2.

At operation 604, a customer taps a left virtual indicator. The left virtual indicator permits selection of a less expensive product than currently displayed. Alternatively, the customer can make a left gesture from the virtual representation of the product.

At operation 606, the virtual representation of the product of operation 602 is replaced with a virtual representation of the less expensive product.

At operation 608, the customer taps a right virtual indicator. The right virtual indicator permits selection of a more expensive product than currently displayed. Alternatively, the customer can make a right gesture from the virtual representation of the product.

At operation 610, the virtual representation of the product of operation 606 is replaced with a virtual representation of the more expensive product.

At operation 612, the customer taps or gestures at a virtual indicator corresponding to a selection of a product from a different manufacturer than for the product currently displayed and the customer selects the different manufacturer.

At operation 614, a virtual representation of a comparable product to the product currently displayed, but from a different manufacturer is displayed on the AR device.

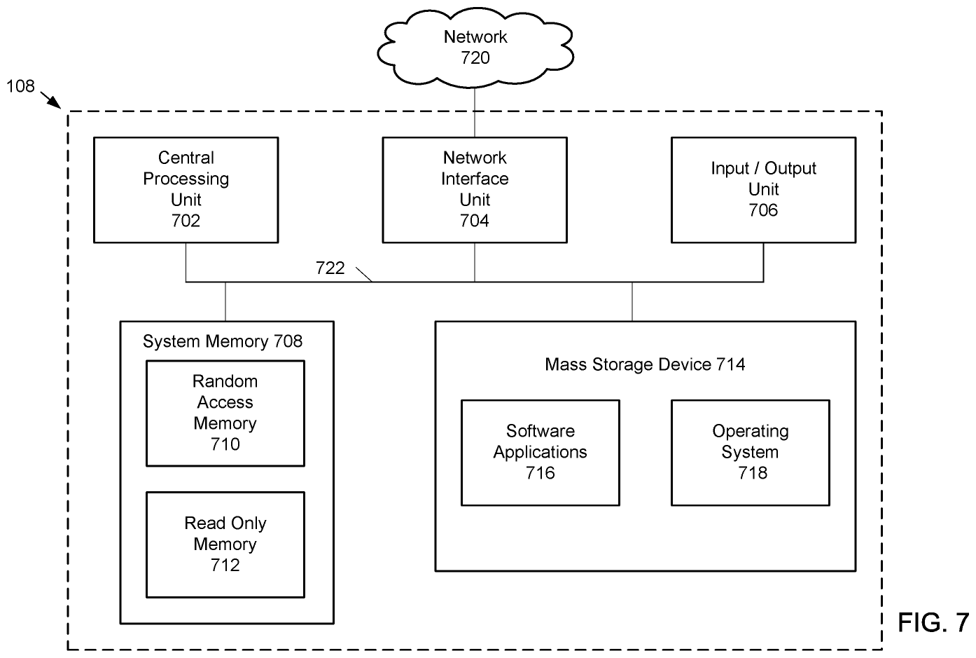

As illustrated in the example of FIG. 7, server computer 108 includes at least one central processing unit (“CPU”) 702, a system memory 708, and a system bus 722 that couples the system memory 708 to the CPU 702. The system memory 708 includes a random access memory (“RAM”) 710 and a read-only memory (“ROM”) 712. A basic input/output system that contains the basic routines that help to transfer information between elements within the server computer 108, such as during startup, is stored in the ROM 712. The server computer 108 further includes a mass storage device 714. The mass storage device 714 is able to store software instructions and data. Some or all of the components of the server computer 108 can also be included in AR device 102.

The mass storage device 714 is connected to the CPU 702 through a mass storage controller (not shown) connected to the system bus 722. The mass storage device 714 and its associated computer-readable data storage media provide non-volatile, non-transitory storage for the server computer 108. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server computer 108.

According to various embodiments of the invention, the server computer 108 may operate in a networked environment using logical connections to remote network devices through the network 720, such as a wireless network, the Internet, or another type of network. The server computer 108 may connect to the network 720 through a network interface unit 704 connected to the system bus 722. It should be appreciated that the network interface unit 704 may also be utilized to connect to other types of networks and remote computing systems. The server computer 108 also includes an input/output controller 706 for receiving and processing input from a number of other devices, including a touch user interface display screen, or another type of input device. Similarly, the input/output controller 706 may provide output to a touch user interface display screen or other type of output device.

As mentioned briefly above, the mass storage device 714 and the RAM 710 of the server computer 108 can store software instructions and data. The software instructions include an operating system 718 suitable for controlling the operation of the server computer 108. The mass storage device 714 and/or the RAM 710 also store software instructions, that when executed by the CPU 702, cause the server computer 108 to provide the functionality of the server computer 108 discussed in this document. For example, the mass storage device 714 and/or the RAM 710 can store software instructions that, when executed by the CPU 702, cause the server computer 108 to display received data on the display screen of the server computer 108.

Although various embodiments are described herein, those of ordinary skill in the art will understand that many modifications may be made thereto within the scope of the present disclosure. Accordingly, it is not intended that the scope of the disclosure in any way be limited by the examples provided.

1. A method implemented on an augmented reality device, the method comprising:
receiving from an electronic computing device a list of one or more products that a user is pre-qualified to purchase;
receiving from the electronic computing device one or more virtual objects, each of the one or more virtual objects being a virtual representation depicting a shape of a product that the user is pre-qualified to purchase;
receiving an image of a view obtained via the augmented reality device;
identifying one or more positions in the view obtained from the augmented reality device in which to display the one or more virtual objects;
displaying the one or more virtual objects in the identified one or more positions on the image of the view, each of the one or more virtual objects depicting the shape of the product in augmented reality within the image of the view;
displaying a plurality of virtual indicators near each corresponding virtual object, with:
a price virtual indicator of the virtual indicators indicating whether a product associated with the corresponding virtual object is affordable to the user;
a less expensive virtual indicator of the virtual indicators being located adjacent to the price virtual indicator, and as a result of receiving a selection of the less expensive virtual indicator, replacing the corresponding virtual object with a second virtual object being associated with a product having a lower price than the product;
a more expensive virtual indicator of the virtual indicators being located adjacent to the price virtual indicator, and as a result of receiving a selection of the more expensive virtual indicator, replacing the corresponding virtual object with a third virtual object being associated with a product having a greater price than the product;
a comparable product virtual indicator of the virtual indicators, and as a result of receiving a selection of the comparable product virtual indicator, displaying a list of comparable products from a same or a different manufacturer;
a product feature virtual indicator of the virtual indicators, and as a result of receiving a selection of the product feature virtual indicator, displaying a list of features associated with the product and one or more selectable options associated with each of the features; and
a payment advisor virtual indicator of the virtual indicators, and as a result of determining that the virtual object is not affordable to the user, providing guidance to the user to help improve the user's financial health, including displaying one of: ideas for the user to earn more money and ideas for the user to reduce expenditures;
wherein each of the price virtual indicator, the less expensive virtual indicator, the more expensive virtual indicator, the comparable product virtual indicator, the product feature virtual indicator, and the payment advisor virtual indicator is displayed adjacent to a respective one of the one or more virtual objects in the augmented reality within the image of the view;
receiving a selection of a first virtual object of the one or more virtual objects, the first virtual object being associated with a first product of the one or more product that the user is pre-qualified to purchase; and
initiating a purchase of the first product.

2. The method of claim 1, further comprising adjusting a position or rotation of one or more of the virtual objects in the view.

3-6. (canceled)

7. The method of claim 1, further comprising:
as a result of replacing the virtual object with the third virtual object representing the more expensive product, determining whether the user qualifies for purchasing the more expensive product; and
when a determination is made that the user qualifies for the more expensive product, provide a visual indication to the user that the more expensive product is affordable.

8. The method of claim 7, further comprising:
when a determination is made that the user does not qualify for purchasing the more expensive product, display one or more suggestions of how the user can change one or more behaviors so that the user will be able to qualify for purchasing the more expensive product.

9. The method of claim 1, further comprising displaying a price of the product associated with the one of the virtual objects as the price virtual indicator.

10. The method of claim 9, further comprising displaying the price of the product associated with the one of the virtual objects in a color corresponding to an affordability of the one of the virtual objects or displaying the price virtual indicator in the color corresponding to the affordability of the one of the virtual objects.

11. The method of claim 1, further comprising:
displaying a virtual automobile on a driveway of the user; and
displaying different views of the virtual automobile as the user walks around the virtual automobile on the driveway.

12-20. (canceled)
